(19) United States
(12) Patent Application Publication
(10) Pub. No.: US 2007/0038861 A1
(43) Pub. Date: Feb. 15, 2007

(54) Marking techniques for tracking pirated media content

(75) Inventors: Barry Jay Weber, CARMEL, IN (US); Ion Vizireanu, West Lake Village, CA (US); Patrick John Shevlin, Thousand Oakes, CA (US); Ahmad Ouri, Glendale, CA (US)

Correspondence Address: THOMSON LICENSING INC., PATENT OPERATIONS, PO BOX 5312, PRINCETON, NJ, 08543-5312, US

(73) Assignee: THOMSON LICENSING INC., PRINCETON, NJ (US)

(21) Appl. No.: 10/554,334

(22) PCT Filed: Apr. 26, 2004
(86) PCT No.: PCT/US04/12748

§ 371 Date: Oct. 24, 2005

Related U.S. Application Data
(60) Provisional application No. 60/465,661, filed on Apr. 25, 2003.

(51) Int. Cl. H04L 9/00; H04N 7/167

(52) U.S. Cl. 713/176; 380/200; 380/201; 380/203

(57) ABSTRACT

A system and method for generating forensically marking image data from source material. A generated forensic mark will vary from copy to copy by using a selected forensic marking technique and forensic marking parameters that change from copy to copy of the source image data.

### FIELD OF THE INVENTION

The invention concerns the field of forensic marking, specifically for creating forensic marks for media replicated in large quantities.

### BACKGROUND OF THE INVENTION

Piracy of entertainment produced by movie studios and music companies is becoming a large concern. The storage medium such as the compact discs (CD), digital versatile discs (DVD), and videotapes used to distribute content created by entertainment copies are easily copied. Many pirates use tools such as CD/DVD burners and Video Tape Recorders (VTRs) to directly copy the CDs, DVDs, and videotapes to other CDs, DVDs, videotapes, and other types of physical mediums.

Additionally, with the advances in video capture and compression, it is now possible to extract a movie from a DVD and transmit the extracted contents over the Internet. This extracted or “ripped” movie is easily disseminated through an architecture called a peer-to-peer network that allow a user to transmit the ripped movie to other users through the simple use of a client program. Hence, it is fairly simple for a pirate to distribute the content of just one CD or DVD to the rest of the world. Entertainment companies and the companies that mass replicate media on therefore would want to utilize system architecture to create CDs, DVDs, and videotapes that could protect against the illicit transfer of media.

### SUMMARY OF THE INVENTION

A system and method are disclosed for forensically marking copies generated from source material. Specifically, the copies are uniquely marked with different forensic marks using different forensic marking techniques. The forensic mark selected will vary from copy to copy of said source material.

### BRIEF DESCRIPTION OF THE DRAWINGS

FIG. 1 shows an exemplary top level generic DVD data format compatible with recordable and read-only DVD players, according to an embodiment of the invention;

FIG. 2 shows a read-only DVD data format indicating volume/file structure and video program navigation information, according to an embodiment of the present invention;

FIG. 3 shows a system diagram for replicating DVDs that are forensically marked, according to an embodiment of the present invention;

FIG. 4 shows a system diagram of a system controller, according to an embodiment of the present invention;

FIG. 5 shows a system diagram of a compute system, according to an embodiment of the present invention;

FIG. 6 shows a system diagram of a DVD controller used for creating DVDs, according to an embodiment of the present invention;

FIG. 7 shows a flow chart of the system methodology used to replicate and forensically mark a DVD, according to an embodiment of the present invention;

FIG. 8 shows an illustration of a forensic marking technique utilizing anchor points and offsets, according to an embodiment of the present invention;

FIG. 9 shows an illustration of a forensic marking technique using forensic marks located at various anchor points, according to an embodiment of the present invention;

FIG. 10 shows an illustration of a forensic marking technique that varies the frame interval for displaying a forensic mark, according to an embodiment of the present invention;

FIG. 11 shows an illustration of a forensic marking technique that varies the duration between frame intervals for displaying a forensic mark, according to an embodiment of the present invention;

FIG. 12 shows an illustration of a forensic marking technique that varies the display of credits, according to an embodiment of the present invention.

### DETAILED DESCRIPTION OF THE EMBODIMENTS

The detailed description describes the use of security marks known as forensic marks that allow the creator or reproducer of media to track the distribution of such media. Preferably, a forensic mark must be robust and survive a variety of video processing transformations, some of which occur “naturally” during content production, for example, digital capture (quantization of an analog signal), compression (MPEG, DV), video noise reduction, frame rate conversion for film to TV frame rates, display de-telecine processing, and TV transmission frame rate conversion, 25/30 Hz, 30/25, 24/30 etc. Other adverse video processing transformations can occur during copyright theft, for example, searching for marks and attempting to render them undetectable.

Once content that has been illegally copied is found, the mark must be detected in order that the “key” can be recovered and matched to a serial number that is matched to the source (program copy destination) from which the content theft occurred. Various arrangements have implemented by others that utilize invisible forensic marks and such techniques for invisible marking form part of an ongoing program.

The inventive arrangements disclosed herein are discussed with respect to content distribution as physical mediums of film, CDs, DVD disk and VHS tape. However, the inventive concepts and algorithms are not so limited and are equally applicable to any video signal largely without regard to the distribution medium.

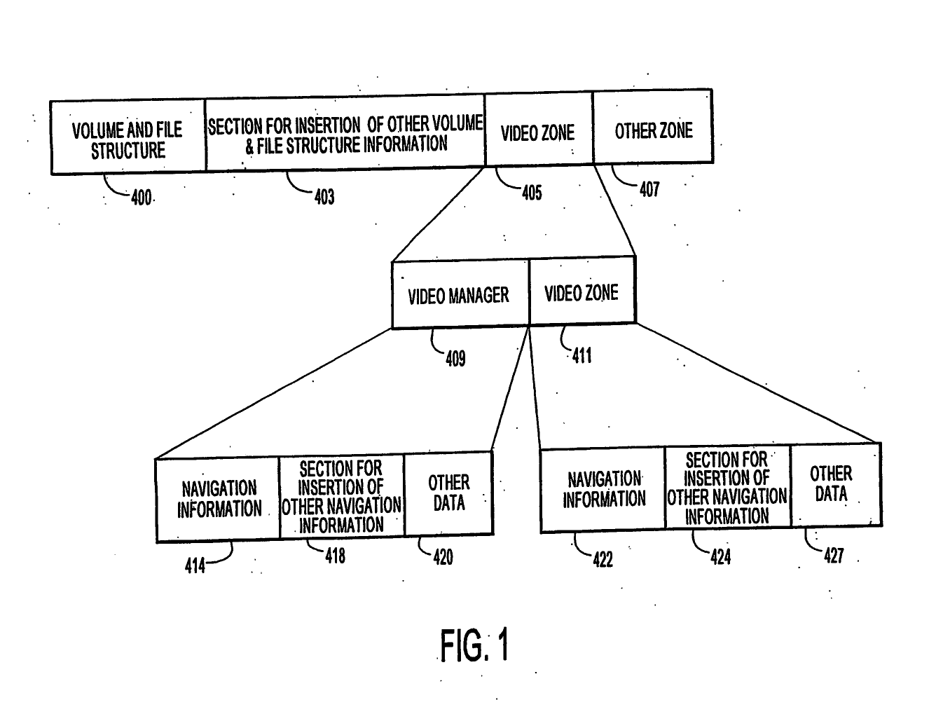

FIG. 1 shows an exemplary top-level generic DVD data format compatible with recordable and read-only DVD players. The highest level of the hierarchical generic data format comprises volume and file structure section 400 defining file locations and paths and section 403 for insertion of other volume or file structure information. The highest level also includes video zone 405 including program video content and program guide/menu content and other zone 407 for ancillary and other data. Video zone 405 comprises video manager 409 and video zone 411. Further video manager 409 is hierarchically comprised of navigation information 414 and data section 418 for insertion of navigation information and other data in section 420. Video Zone 411 is comprised of navigation information 422 and data section 424 for insertion of navigation information generated in post-processing mode and other data in section 427.

The file structure and navigation parameters incorporated within the generic format of FIG. 1 support navigation through images in an MPEG compatible group of pictures (GOP) or within a DVD video object unit (VOBU). The parameters also support navigation within a single program or between different programs including audio programs, Internet web page data, text data, and program guides and between images of different MPEG elementary streams. Specifically, navigation parameters may include, for example, parameters identifying individual GOPs, or the number of GOPs in a video object unit (VOBU), or image data location information. Further, such location information may include data, identifying the size of image representative data, or identifying MPEG reference frames in a VOBU or GOP, or identifying image representative data start or end addresses. In addition, the navigation parameters may also include trick play mode selection information.

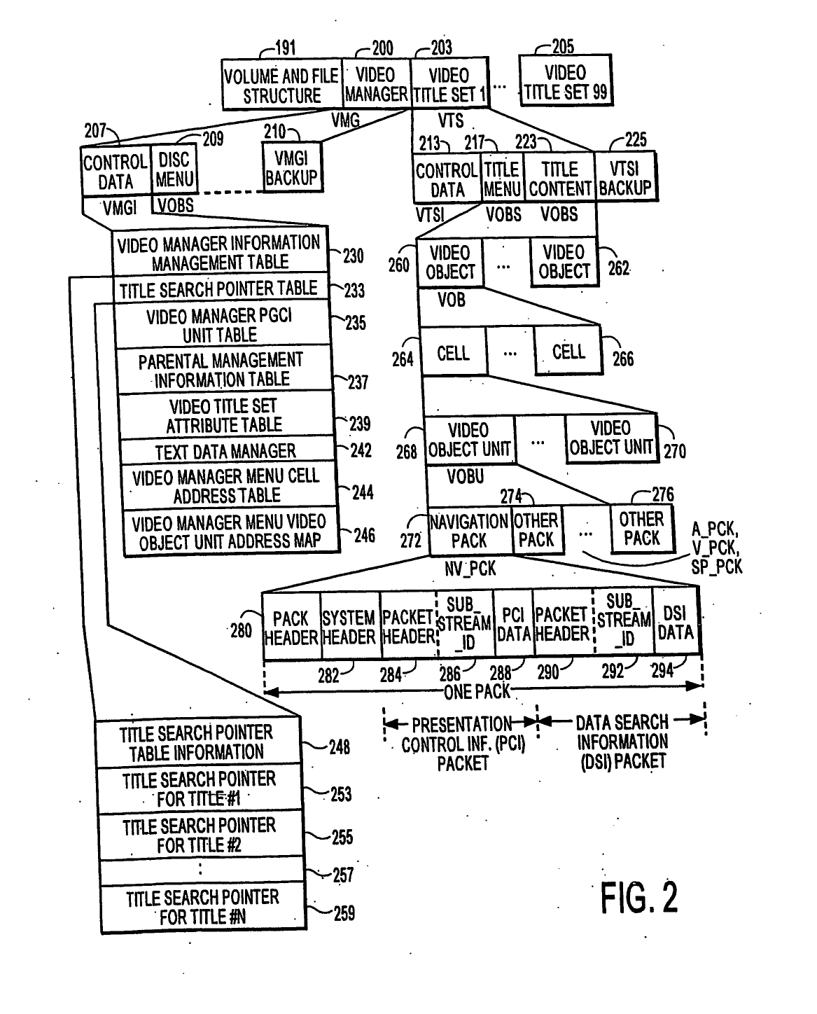

FIG. 2 shows an exemplary embodiment of a DVD hierarchical data format indicating location and structure of navigation information used in decoding and navigating through video program image sequences for different modes of operation. The highest level of the hierarchical read-only data format comprises, volume and file structure data 191, a video manager section (VMG) 200 and video title (program) sets (VTS) 203-205 including video program content. Each VTS is hierarchically associated with: video title set information VTSI 213 for one or more video programs (titles); program menu information 217; program content information 223 and back-up VTSI data 225. Further, program menu information 217 and program content information 223 are comprised of video objects (VOB) 260-262 and an individual VOB (e.g. VOB 260) is comprised of cells 264-266. An individual cell, e.g. cell 264, represents program data of duration that is variable from 1 second to the length an entire movie, for example. Cell 264 is comprised of video object units (VOBU) 268-270 and each video object unit represents 0.4-1.2 seconds of video program play. Each individual video object unit (exemplified by units 272, 274-276) may include navigation pack information together with video, audio and sub-picture data (comprising captions, and ancillary text, for example). An individual navigation pack includes headers, sub-stream_ids, presentation control information (PCI) data, and data search information (DSI) as shown in units 280-294.

The main menu of a DVD disc in video manager section (VMG) 200 is optional. This main menu represents the first image a User sees on accessing a DVD disk. VMG 200 is hierarchically associated with video manager control data 207, disc menu 209 and video manager back-up information 210. Further, control data 207 comprises: information management table 230; title search pointer table 233; menu program chain information unit table 235; parental management information table 237; video title set attribute table 239; text data manager 242; menu cell address table 244; and menu video object unit address map 246. Specifically, items 230-246 define size and start addresses of VMG information, attributes of video objects of the video manager menu, video program search information, menu language information, parental rating control information, duplicate video program attribute information, and program identification names (e.g. volume, album or producer names). Further, title search pointer table 233 includes search information items 253, 255, 257 and 259 each specifying program type, program number, number of camera angles, parental rating identifier and program start address, for example) for each program on a disk. Title search pointer table 233 also includes in item 248 parameters defining size and location of search pointer table 233.

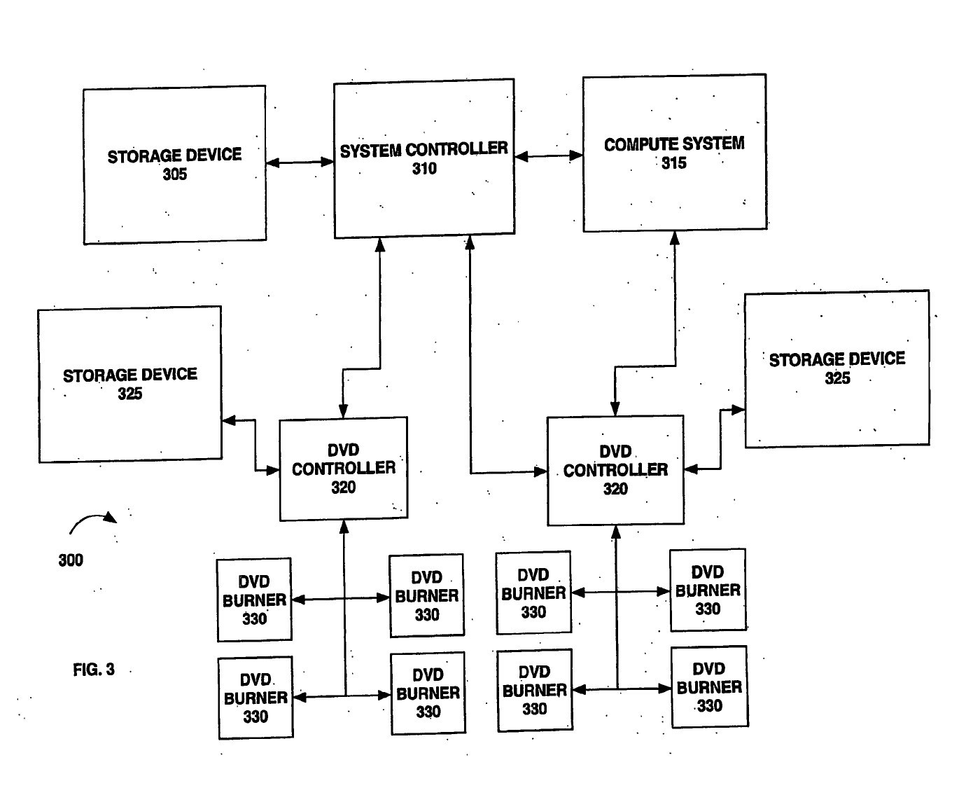

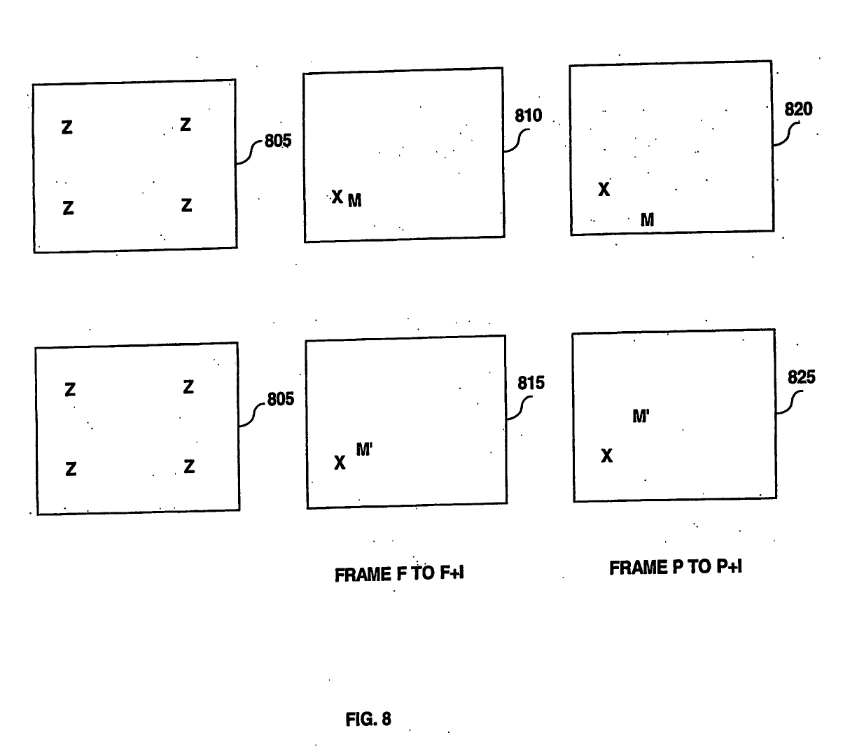

FIG. 3 is a diagram of system architecture 300 for DVD replication that forensically marks the DVD being reproduced. The architecture modifies GOPs of VOB file used to create the DVD by inserting forensic marks into the GOPs before the VOB is recorded on the DVD medium. The forensic mark used in the GOP may be any one as described in association with FIGS. 8, 9, 10, 11, and 12.

Storage device 305 is preferably a storage device capable of storing gigabytes (GB) or tetrabytes (TB) of video and audio information. When source material of a DVD is loaded into storage device 305, both system controller 310 and compute system 315 recognize the presence of such material, so that the source material may be copied to DVDs. The source material is represented as a file within the context of operating systems as WINDOWS, LINUX, UNIX, and the like.

System controller 310 is preferably a computer or other type of processing means capable of running WINDOWS or LINUX based software. In the preferred embodiment, system controller 310 uses a WIN32 based user interface and software resource manager modules to operate the other components of architecture 300 through network connections such as Ethernet, Firewire, a T1 or T3 connection, and the like. The user interface will display current and historical job status, collect information for creating new jobs, and provide controls for managing jobs. Alerts are also displayed via the user interface to notify operators of job completions or problems with job executions.

System controller 310 as a processing means uses the resource manager software to listen for connections between DVD controllers 320 and compute system 315, and to operate a MICROSOFT ACCESS database that lists the active resources in architecture 300. Specifically, the database uses ODBC or JBDC to read and write the persistent data required by the applications operating in the system architecture

Compute system 315 is preferably a computer capable of operating on a network that operates a program for controlling the copying of source material on storage device 305 to DVD controller 320. Some of these operations include the actual forensic marking to the VOB being written for a DVD creating a modified DVD image, the transporting of a modified DVD image to DVD controller 320, assigning a serial number to the image transported to DVD controller 320, and the label graphic physically printed on the DVD. Preferably, the serial number will be printed as barcode as part of the graphic printed on the DVD.

DVD controller 320 is a networkable device that controls the replication of DVD image data to DVDs. DVD controller 320 operates a bank of DVD burners 330 coupled to controller 320 preferably through a 1394 based connection. DVD controller 330 comprises three components: a session manager, a UDP file copy client, and an interface driver, which are explained elsewhere in this specification. Storage device 325 is a mass storage device capable of storing data representing the DVD image received by DVD controller 325. DVD burners 330 are an example of a copying means utilized for copying DVDs, while a VTR is an example of a copying means used for replicating videotapes.

An overview of the copying process begins with a user entering in via system controller 310 parameters about the source material to be copied and the forensic marking method to be used for the copying job. The copying operation is assigned a job that is tracked by system controller 310. When the copying job is started, system controller 310 notifies compute system 315 of the requirements required for the job such as the number of copies, forensic marking method to be used, any graphics information for the label, what DVD image is to be copied, and the like. In response to these requirements, compute system 315 communicates with one or more DVD controllers 320 as how to service the job. If it is determined that the appropriate resources are not available for the copying job (not enough available DVD drives 330 or memory), system controller 310 will place the job in a ready queue, until such resources are available.

If the appropriate resources are available, compute system 315 establishes a connection with DVD controller 320 that coordinates the transmission of the source material from storage device 305 to DVD controller 320. Preferably, the copying is done via User Datagram Protocol (UDP) based architecture as described in Postel, J., “User Datagram Protocol,” Request For Comments 768, USC, Information Sciences Institute, August 1980. Before copying VOB files of the source material to DVD controller 320, compute system 315 extracts GOPs from the source material and applies a forensic mark to the GOP. The forensic mark used may be any of the marking techniques presented in FIGS. 8, 9, 10, 11, and 12, as with other forensic marking techniques.

Once the GOPs are marked, compute system 315 transmits the marked VOB files to DVD controller 320. The DVD burning process is activated by DVD controller 320 creates a thread that uses a DVD burner software program (as produced by RIMAGE) to control the burn. Specifically, the software program acts as an Application Program Interface (API) that uses callbacks to notify the thread of status activity on the burn. This status information is forwarded to system controller 310 that stores such information and uses this information as the basis of any notifications shown via the user interface system. When the burning of the DVD is running, DVD controller 320 downloads the next image to be burned.

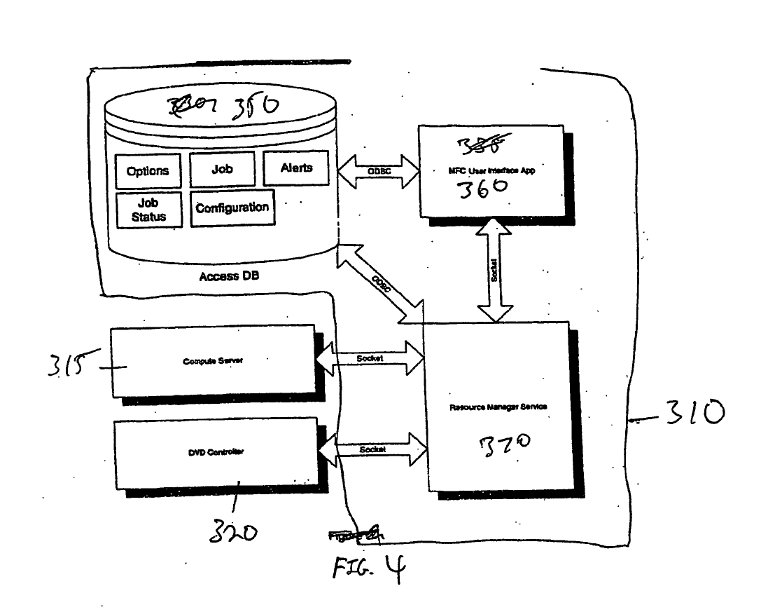

FIG. 4 presents a block diagram of the system components used by system controller 310 to manage the DVD copying process. Database 350 uses a program such as MICROSOFT ACCESS or other relational databases utilizing an Open Database Connection data format (ODBC) or a JAVA Database Connectivity data format (JBDC) to read and write persistent data required by both the user interface 360 and resource manager 370. Database 350 stores system architecture information related to the options selected by a user for a copy job, the copy job running during a copying operation, system alerts, job statuses, and configuration data about system 300. Database 350 also stores system messages from compute server 315 and DVD controller 320.

As stated above, user interface 360 is a Microsoft Foundation Class (MFC) application that accesses database 350 for job and configuration information via ODBC connection. When a copying job is started, user interface 360 connects to resource manager 370 to issue the request to start the copying job via a socket connection.

Upon the receipt of the information indicating the starting of a copy job from user interface 360, resource manager 370 communicates through a socket connection to select DVD controller 320 to handle the copy job and connects to an available compute system 315 to perform to do the processing of the copy job. Resource manager 370 also suspends or cancels copy jobs based on the messages received from user interface 360.

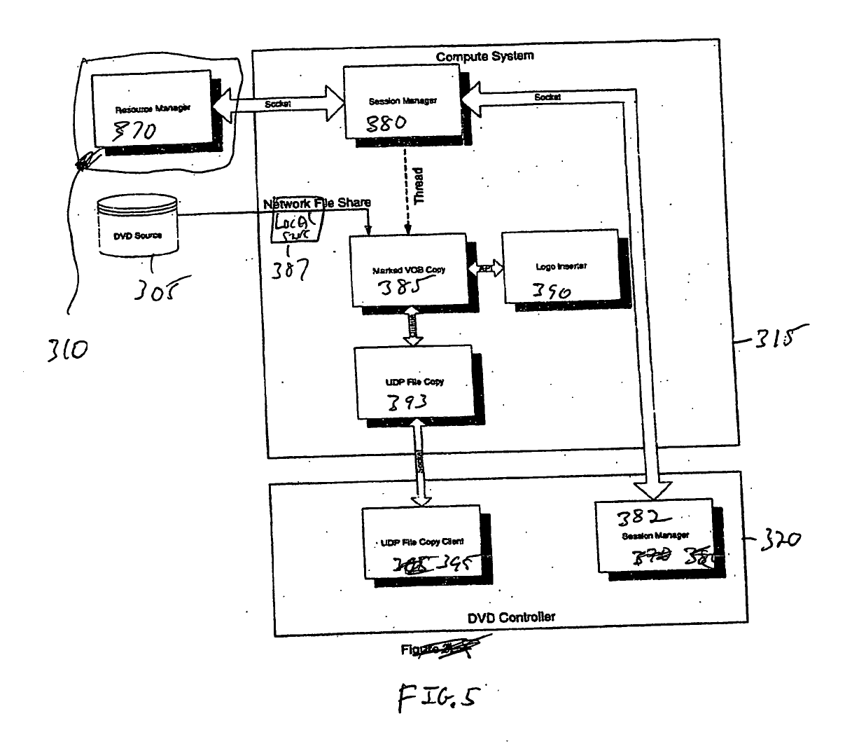

FIG. 5 is a system diagram of the operation of compute server 315 in system 300. Specifically, session manager 380 is the software program in compute server 315 responible for communication between system controller 310 and DVD controller 320. Session manager 380 establishes a socket connection to resource manager 370 and starts the file transfer threats that are used to mark and transport data to DVD burner 330 for the eventual DVD burning process.

The command starting a copy job from resource manager 370 to session manager 380 contains a reference to the network fie share directory in storage device 305 where the image of the DVD to be copied exists. The command will also contain the Internet Protocol address of the DVD controller 320 used for the DVD burning, and control information such as the starting serial number of the DVD copy, the type of forensic marking to be inserted by logo inserter 390, the number of DVD copies to make, and the like. A connection is then established between session manager 380 and DVD controller 320.

Session manager 380 is also responible for copying the DVD image from storage device 305 to local storage 387. When the copying of the DVD image to local storage 387 is complete, resource manager 370 is notified. Resource manager 370 then instructs session manager 380 to start the DVD burn job.

Before the DVD burn job is started, session manager 380 informs marked VOB copy 385 to take parts of the VOBs stored in local storage 387, and proceeds to mark the VOBs with logo inserter 390 using a forensic marking technique. Preferably, the forensic mark is any of the marks shown in FIGS. 8, 9, 10, 11, and 12. Alternatively, the mark selected is a logo or a serial number that corresponds to the Network Identification Control number of the DVD burner 30 that will eventually burn the DVD image and the time the DVD burn was started or completed. This mark will be inserted into different frames of the VOB for a length of time, or in accordance with the forensic marking techniques described below. Marked VOB copy 385 stores the marked VOB copy marked by logo inserter 390.

When session manager 380 receives notification from marked VOB copy 385 that the marking of the VOB of the DVD image is complete, session manager 380 instructs DVD controller 320 to start the DVD burning process. Session manager 380 controls marked VOB copy 385 to use UDP file copy 393 to coordinate the transfer of the marked DVD copy from marked VOB copy 385 to DVD controller 320. UDP file copy 393 is informed as to which IP address of DVD controller 320 to connect to, whereby the marked DVD copy is transmitted via a UDP connection to UDP file copy client 395. Session manager 382 of DVD controller 320 works with session manager 380 to insure the successful transfer of the marked DVD.

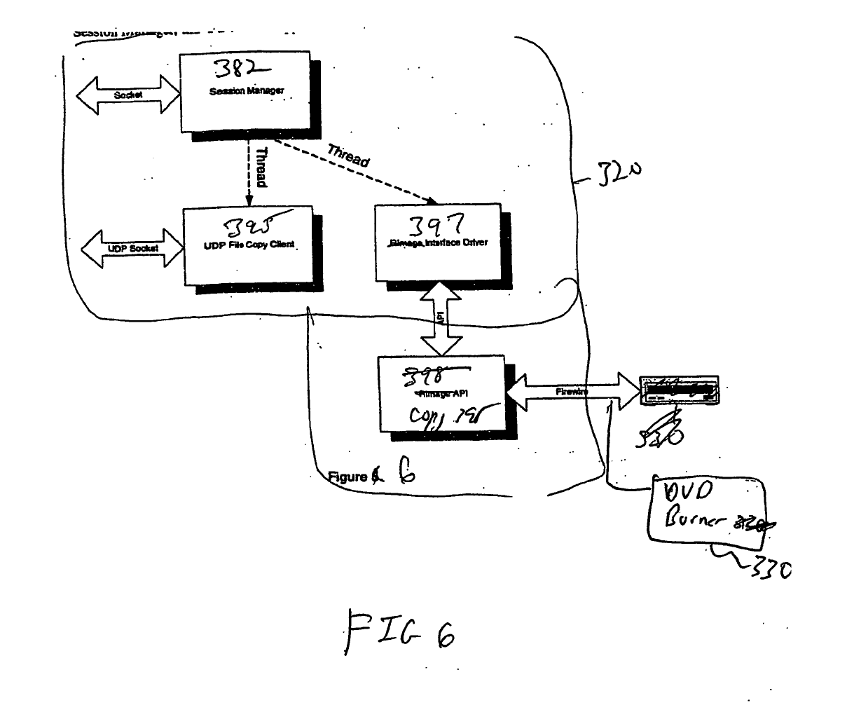

FIG. 6 is a system diagram of the operation of DVD controller 320. Session manager 382 communicates with resource manager 370 to report the status of DVD controller 320. Information reported to resource manager 370 includes parameters such as the IP address of DVD controller 320, available port numbers, and the number DVD burners 330. Session manager 382 also operates UDP file copy client 395 and interface driver 397 that uses copy threads to control DVD burners 330 through a copy API 398.

Session manager 382 awaits a connection from session manager 380 (in compute system 315) to start the burning of a marked. DVD image. Upon this request, session manager 382 notifies UDP file copy client 395 of the request. Once UDP file copy client 395 receives the marked DVD image, session manager 382 instructs interface driver 397 to start the actual burn of the DVD image by DVD burner 330. Session manager 382 also terminates the burning of a DVD image, upon a received command, and reports the termination of the job to resource manager 370.

UDP file copy client 395 receives a marked DVD image and instructions from compute system 315 over a UDP socket. The instructions consist of file names to create, end of file markers, and end of session indicators. Client 395 is also responible for creating the requested files and copying marked DVD image data to DVD burner 330. Session manager 382 is responible for the operation of client 395 by providing an IP address that client 395 binds to (as a UDP socket) for reading data. Once all the marked DVD image data is received, the UDP socket is closed and session manager 382 is informed the transfer is complete. System controller 310 is eventually that the transfer is completed, as well.

Interface driver 397 is responible for using copy API 398 to start a DVD burn job and to monitor all of the callbacks from copy API 398. Session manger 382 informs interface driver 397 of the directory of where the marked DVD image data is stored. Interface driver 397 calls copy API 398 to start the copy job function, whereby API 398 coordinates the actual copy of the image data to DVDs burned by DVD burners 330. The callbacks are used to start, end, and describe the copying process are transmitted back from to interface driver 397 to session manager 382 as socket messages. When the burning operation is completed, session manager 382 sends the socket message back to compute system 315 as to await further instructions for future copying jobs.

Optionally, DVD image data is stored in local storage device 325 by DVD controller 320. By being a mass storage device such as an array of hard disks, or server capable of storing Gigabytes or Terabytes of data, storage device 325 is capable of storing the image data of multiple DVDs. DVD controller 320 may use these multiple image files to create a DVD via DVD burner 330 from a first DVD image, and a second DVD via a second DVD burner 330 from a second DVD image.

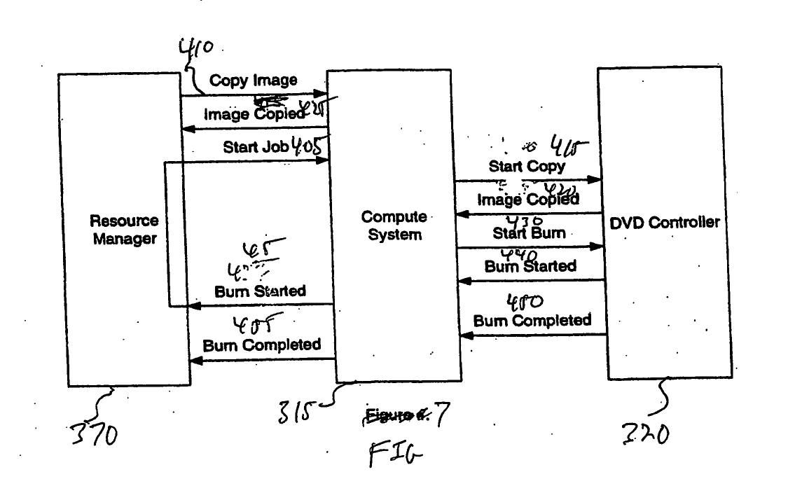

FIG. 7 presents a method of the copy process used of system 300, as described above. Step 405 starts with resource manager 370 requesting a copy job to compute system 315. Resource manager 370 then copies a specified DVD image from storage device 305 to compute system 310 in step 410. Compute system 315 then informs DVD controller 320 to start a copy job in step 415. During this step, compute system 315 marks the source DVD image into a marked image data and transmits this data to DVD controller 320.

When DVD controller finishes copying the image data, compute system 315 is informed of this completion in step 425. Compute system 315 then instructs DVD controller 320 to start burning of the marked image data in step 430 via DVD burner 330. DVD controllers informs compute system 315 that the burning has started in step 440 which is in turn communicated to resource manager 370 in step 445.

When DVD controller 320 completes the burning of the marked DVD image data, controller 320 informs compute system 315 about the completion of the copying job in step 450. Resource manager 370 then receives the message the burn job is complete in step 455 by compute system 315, where resource manager 370 is capable of starting a new copy job as in step 405. It is to be appreciated with the system described in FIGS. 1, 2, 3, 4 ,5, 6, and 7 may utilize invisible watermarks, as known in the mark.

FIGS. 8, 9, 10, 11, and 12 illustrate various embodiments of forensic marks that may be used by logo inserter 390 for marking the VOBs of a DVD image file. These embodiments may also be used in other systems such as by broadcasters transmitting programming via cable, satellite, terrestrial, or over the network. Ideally, part of the transmission network has the capability of adding the described forensic marks to the video transmitted from the broadcaster. An encoder used to encode a video signal for transmission may also add the described forensic marks in as part of the encoded video signal using. Other insertion techniques are to be utilized, in accordance with the principles of the present invention.

Specifically, the described forensic marking techniques described operate in 5 dimensions (5D) such as the X coordinate plane, Y coordinate plane, time dimension, within the content itself, and hidden marking methods not apparent to pirates. These 5D marking techniques place highly visible text or objects within the active video area of video content. The values of the first 4 dimensions are varied such that a pirate cannot create an automated system to remove the generated forensic marks. The forensic marks generated are done in view of forensic marking parameters that are modified from each copy of the source image data. Such modifications may be random, pre-selected, in accordance with a mathematical algorithm, and the like.

For illustrative embodiments of the present invention, video content such as DVD image data is composed of a series of frames or pictures. For purposes of this specification, the term frame is used interchangeably with the term picture. It is contemplated that forensic marking techniques described below may also be employed for video data that is encoded using MPEG-2 (Motion Picture Standards Group Standard ISO/IEC 13818-1:2000) and ITU-T H.264/MPEG AVC (ISO/IEC 14496-10) compress video data into a sequence of video pictures or pictures that utilize techniques as intra-frame and inter-frame encoding, as known in the art. The term frame also refers to a movie frame or a still picture where a sequence of frames used to create a movie or a video sequence. Other definitions for the term frame may be used, as known in the art. Representations of the generated forensic marks are illustrated through the use of hypothetical video screen, as shown in FIGS. 8, 9, 10, 11, and 12. The forensic marks are overlay the video images of the original source image data using a display means such a On Screen Display (OSD) generator.

Each frame may be referred to as a number, which represents the frame's position in a sequence of pictures. For example, a frame value of 1000 means that the frame's position is one-thousand from the first frame in a sequence of pictures. The term frame count represents an interval of frames. For example, a frame count of 1000 to 2000 refers to the frames from the position of the one-thousandth frame to the position of the two-thousandth frame in a sequence of pictures. Typically, a frame count is used for determining when and for how long a forensic mark is displayed on a video screen. The term frame rate represents the amount of frames shown for a period of one second. For example, a video utilizing a frame rate of thirty frames means that thirty frames are shown every second.

FIG. 8 describes an embodiment of a forensic marking technique that changes the offset of a forensic mark from an anchor point. Video screen 805 represents an illustrative embodiment of the present invention, where the Zs represent different anchor locations from where a forensic mark may be generated. In the present embodiment, the Zs are anchor locations that represent the top left, top right, bottom left, and bottom right. From a selected anchor location, a generated mark is offset from a selected location. This offset is known as the hidden dimension, as referred to above, where the offset for each copy of DVD or a VHS tape is different.

A forensic mark may be a graphic element such as a logo, text, or any other visual object. The invention provides that different types of forensic marks may be generated for copies of the same source material. Additionally, the displayed forensic mark may have the attributes of the display text such as font type, font size, font color, and font orientation may vary from copy to copy. For example, a serial number corresponding to a DVD being burned may be the visual information used for forensic mark. This forensic mark is shown as the serial number in a twelve point Arial font. A second DVD being burned would use its serial number as a forensic mark. In this case, the serial number would be displayed with a different font size and a different font type such as a sixteen point Times New Roman font. Variations in the forensic marks displayed may be selected in accordance with the principles of the present invention.

An offset is generated utilizing information such as the serial number corresponding to the copy being marked, the time the copy is being marked, the physical size of the copying being marked, or any other attribute related to the copy being marked. This value or a combination of values related to the copy being marked is entered into a formula where the result of the formula represents the offset from a selected anchor point. For example, an offset may be calculated by taking the square root of the serial number corresponding to the copy being marked. The amount of the offset then is related to an amount of pixels away from the selected anchor point. This offset is preferably amount of pixels in the X-axis and the Y-axis from which a forensic mark is offset from an anchor point. Other calculations of offset may be used, in accordance with the principles of the present invention.

Video screen 810 represents a video screen with a generated mark M that is offset from anchor point X. Video screen 815 represents a second video screen with a different offset than video screen 810. Hence, the displayed forensic mark M′ is located in a different location from anchor point X than for forensic mark M.

The invention may be used to generate a forensic mark for any interval of frames within a sequence of pictures. In the present embodiment, forensic marks M and M′ are displayed for a duration from frame F to F+I (F being any frame of the video content, I=any positive integer). Preferably during the time interval of F to F+I, a forensic mark moves from its offset to a second location on the video screen. This direction may be randomized, or generated in accordance with a second formula in a manner as described above. The use of moving marks makes it difficult for a pirate to blank out or to fuzz marks to make them difficult to recognize.

Video screen 820 shows that the forensic mark M has moves in a downward left direction from the mark's location in video screen 810. Similarly, video screen 825 shows that forensic mark M′ has moved in an upper left direction from the mark's location in video screen 815. The movement of marks M and M′ continues during frame interval from frame P to P+I (P being a frame position after frame F). The variations in the offsets of display and the associated movement parameters of the various forensic marks may optionally be stored in a database, as used for system controller 310.

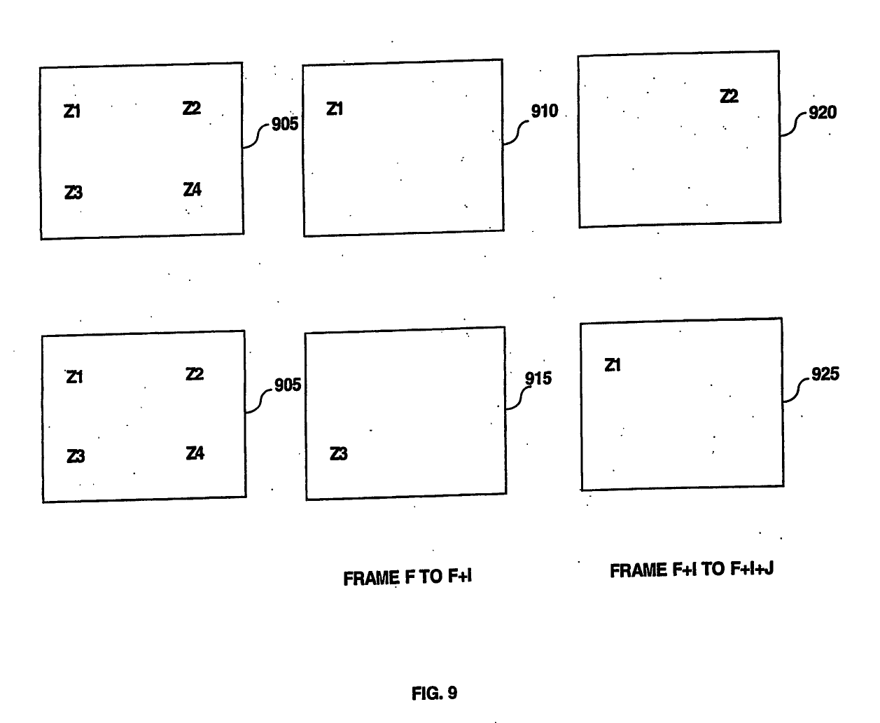

FIG. 9 describes an embodiment of a forensic marking technique that changes the location of a generated forensic mark at different time durations. Video screen 905 represents a video screen showing four different locations Z1, Z2, Z3, and Z4. In this embodiment, a forensic mark is moved between to a first location for a frame interval, and a second location for a second frame interval. The locations selected can be unique to each copy generated from a common source.

For example, video screen 910 of a first copy of source material shows a forensic mark being placed at location Z1 for a duration from frame F to frame F+I. Video screen 915, corresponding to a second copy produced from the same source material, shows that a forensic mark is placed at a location Z3 for a duration from F to frame F+I. Video screen 920, of the first copy, shows that the forensic mark now moves to a second location Z2, for a duration from frame F+I to frame F+I+J (J=any positive integer, where the total amount of pictures in the available sequence of pictures is greater than F+I+J). Video screen 925, corresponding to the second copy, shows that the forensic mark is moved to a different location Z1 than the location used for video screen 920.

The locations that a forensic mark is moved to may be used to create a forensic code that is unique for each copy produced from the same source material. Hence in the present example, the first copy would have a forensic code of (Z1, Z2), while the second copy has a forensic code of (Z3, Z1). This technique helps against frame dropping, where a pirate drops video to eliminate the display of a displayed forensic mark. The locations of forensic marks, the duration for which the marks are displayed, and the variations of locations used for such forensic marks may be varied in accordance with the principles of the present invention. The variations in the locations of display of the various forensic marks may optionally be stored in a database, as used for system controller 310.

In an optional embodiment of the present invention, the forensic code generated by using forensic marking parameters may adopt a form of error correction, such as parity bits, hashing codes, and the like. The system is capable of recognizing a fault in the error correction, which may indicate that a pirate has tampered with a copy of image data. For example, the forensic marking technique used for FIG. 9 would result in an error condition, if the generated forensic mark is in the same place for two frame intervals. Physical attributes of the data comprising the marked image data (such as the size of the image data file) may also be hashed to determine if the data was tampered with. Other error correction techniques are to be utilized in accordance with the principles of the present invention.

Various schemes of error correction may be added, in accordance with the principles of the present invention.

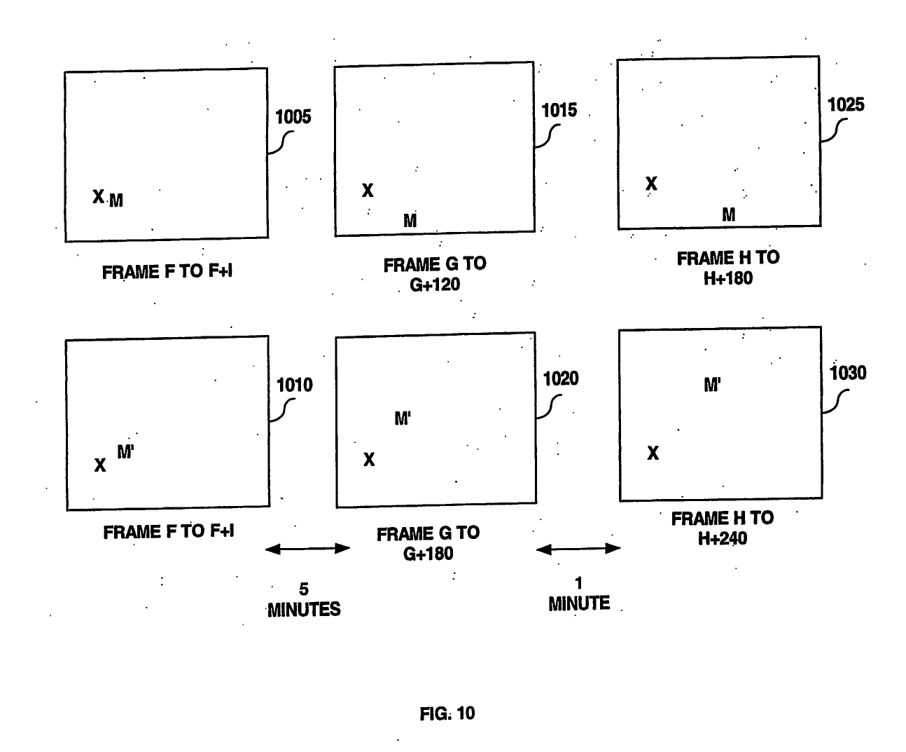

FIG. 10 illustrates an embodiment of a forensic marking technique that changes the durations for which forensic marks are displayed for each copy produced from the same source material. Video screens 1005 (corresponding to first copy) and 1010 (corresponding to a second copy) show forensic marks M and M′, respectively. In the preferred embodiment, the forensic marks are offset from an anchor point X, although the forensic marks may be placed on the screen in any other manner consistent with the principles of the present invention.

Forensic marks M and M′ are displayed on the video screens for a duration from Frame F to F+I (F=a positive integer, where the total amount of pictures is greater than F+I). After a frame count of F+I, forensic marks M and M′ are removed, and for a period of five minutes no forensic marks are shown.

Video screens 1015 (first copy) and 1020 (second copy) displays forensic marks M and M′ after the five period minute period elapses, which corresponds to a frame G (G=is a positive integer greater than F). This time, M and M′ are displayed for different durations of time; M is displayed from frame G to G+120 for video screen 1015, and M′ is displayed from frame G to G+180. After a period of a minute, these marks are removed and the forensic marks are displayed again, but for different durations. Video screen 1025 that corresponds to the first copy displays M from frame H to H+180 (H=is a positive integer than G). Video screen 1030, corresponding to the second copy of the same source material, displays mark M′ from a duration from frame H to H+240. Any duration may be selected in accordance with the principles of this invention. The variations in the durations of display and/or locations of the various forensic marks may optionally be stored in a database, as used for system controller 310.

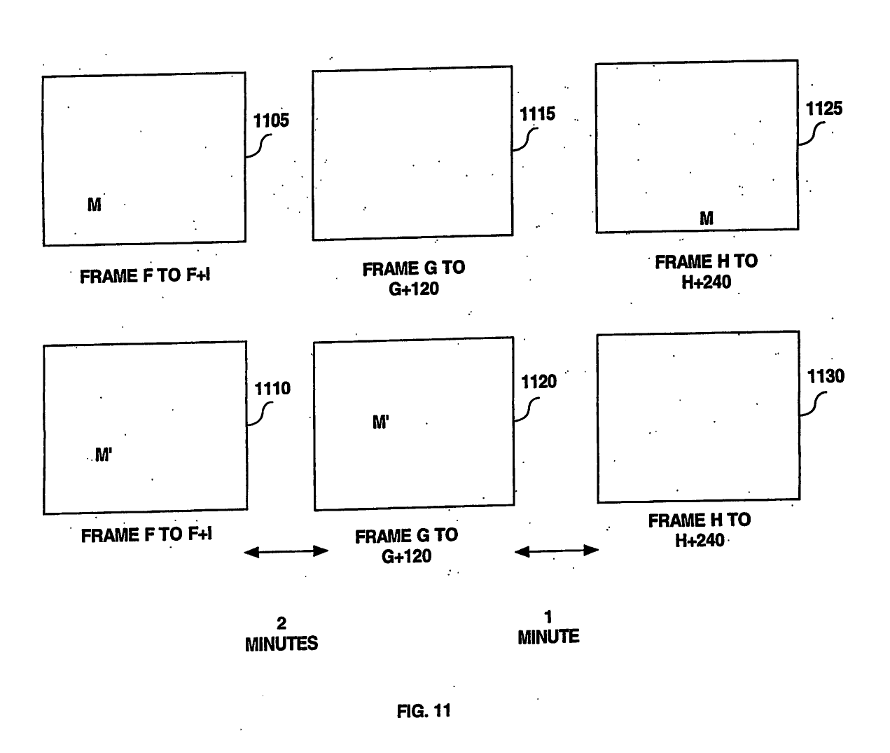

FIG. 11 illustrates an embodiment of a forensic marking technique that changes the durations for which forensic marks are displayed for each copy produced from the same source material. Specifically, this embodiment of the present invention varies the duration for how long forensic marks are presented among the different copies generated from the same source material. For this embodiment, video screens 1105, 1115, and 1125 correspond to a first marked copy of source material, and video screens 1110, 1120, and 1130 correspond to a second marked copy of the same source material.

Video screens 1105 and 1110 displayed forensic marks M and M′, respectively, for a duration from frame F to F′. After a period of two minutes, video screen 1120 displays forensic mark M′ for a duration G to G+120, while a forensic mark M is not displayed during this frame duration as shown in video screen 1115. One minute after G+120, M is shown from frame H to H+240, as shown in video screen 1125, while forensic mark M′ is not displayed during this frame duration, as shown in video screen 1130. This technique alerts the copyright holder when frames are dropped from a pirated copy of source material.

Any duration for when a mark is visible or not visible may be selected in accordance with the principles of this invention. The variations in the durations of display, whether a forensic mark is visible or not, and/or locations of the various forensic marks may optionally be stored in a database, as used for system controller 310.

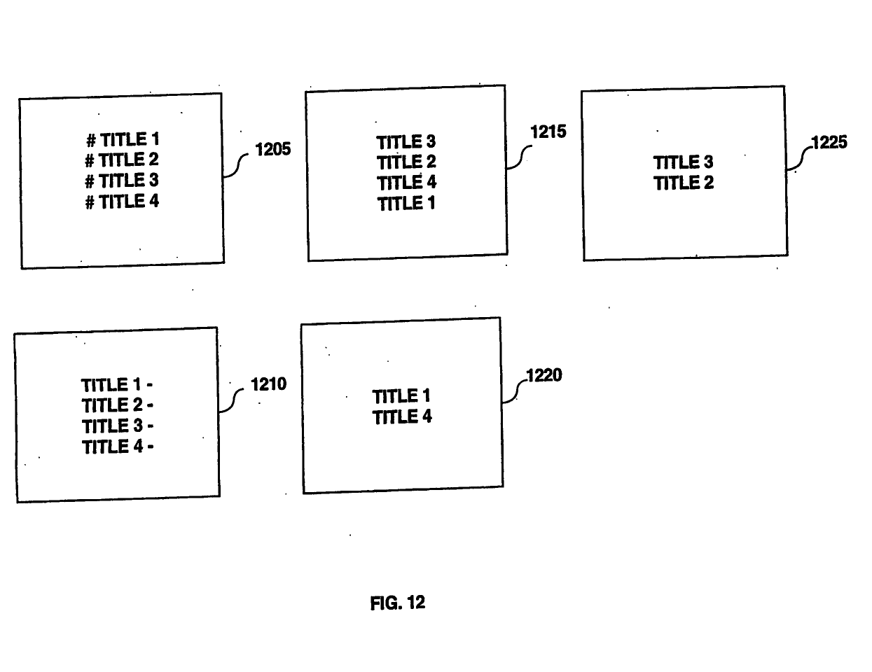

FIG. 12 illustrates an embodiment of a forensic marking technique that changes the credits, as a forensic mark, for each copy produced from the same source material. Video screens 1205, 1210, 1215 correspond to the different marked copies of the same source material, each copy using different forensic marks.

Video screen 1205 displays sample titles, Title 1, Title 2, Title 3, Title 4, in a specific order with a # character appended to the beginning of each title. Video screen 1210 displays the titles in the same order, but a different character—is placed at the end of each title. In contrast, video screen 1215 displays the sample titles in a different order and without the addition of a character at the beginning or end of each title.

Video screens 1220 and 1225 display a different technique that may be used for displaying the credits for a marked copy generated from source material. In this case, the credits are broken up into separate groups where a first group of credits is shown in video screen 1220 (Title 1 and Title 4). A second group of credits (Title 2 and Title 3) is shown afterwards, as illustrated for video screen 1225 (Title 2 and Title 3) for the same copy. The permutation in the order of credits, the characters appended at the beginning or end of the credits, and the grouping of credits may vary from copy to copy, in accordance with the principles of the present invention. These variations in the order and modification of credits may also be optionally be stored in a database, as used for system controller 310.

TABLE 1, as shown below, is an illustrative embodiment of sample forensic marking parameters stored in database 350 which are used to generate a forensic mark for each copy of a DVD image data or videotape image data. Serial number refers to the serial number corresponding to the image being replicated. Anchor location refers to the anchor location (as in FIG. 8) selected for the base position of a displayed mark.

Offset represents the position offset of a mark from a location, in terms of amount of pixels or units that the mark is located away from a designated anchor location. The offset is expressed as X-axis and Y-axis coordinates that may be positive or negative integer values. The offset direction indicates the direction (as represented by X axis and Y axis coordinates) in which a forensic mark will move from its specified offset position. The rate of movement in which a mark moves may be varied according to principles of the present invention.

Frame Start A and Frame End A both represent values indicating the starting and ending position of the sequence of pictures forensically marked. Similarly, Frame Start B and Frame End B indicate the starting and ending positions of the sequence of pictures that are forensically marked. Visual mark represents the forensic mark used. Other variations of values stored in database 350 are to be selected in accordance with the principles of the present invention. These forensic marking parameters may also used to form the basis of the error correction code, as described above.

TABLE 1

| SERIAL | ANCHOR | | OFFSET | FRAME | FRAME | FRAME | FRAME | VISUAL |
|---|---|---|---|---|---|---|---|---|
| NUMBER | LOCATION | OFFSET | DIRECTION | START A | END A | START B | END B | MARK |
| ZAW43 | TOP LEFT | (3, 2) | (0, 3) | 1500 | 1800 | 2344 | 2900 | TEXT |
| XCF4D2 | TOP LEFT | (−4, 6) | (3, 0) | 1700 | 1800 | 2500 | 2900 | TEXT |
| R2D2A | BOTTOM RIGHT | (1, −2) | (2, 1) | 1900 | 3400 | 4533 | 5000 | LOGO |
| 23Q77 | BOTTOM RIGHT | (0, 2) | (1, 1) | 1434 | 2214 | 7000 | 9000 | SERIAL |

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

1-11. (canceled)

12. A method for marking video image data comprising the steps of:
selecting a security mark;
modifying said security mark for each copy of said video image data; and
inserting said security mark into respective copies of said video image data.

13. The method of claim 12, wherein said step of modifying is performed by using a marking parameter that determines how said security mark is modified.

14. The method of claim 13, wherein said marking parameters comprises:
a value corresponding to an anchor point; and
an offset corresponding to a location from said anchor point, wherein
said security mark is displayed at said location from said anchor point.

15. The method of claim 12, wherein said security mark moves in a direction corresponding to an offset direction value having an x-axis component and a y-axis component when displayed.

16. The method of claim 12, wherein said security mark is displayed at a first anchor location for a frame interval; and said security mark is displayed at a second anchor point for a second frame interval.

17. The method of claim 12, wherein said first anchor point and said second anchor point are different.

18. The method of claim 12, wherein the frame interval corresponding to a duration for which a security mark is displayed varies from said copy to copy of said video image data.

19. The method of claim 12, wherein said security mark is displayed for a frame interval for a first copy of said image data and said forensic mark is invisible for said frame interval for a second copy of said image data.

20. The method of Clam 12, wherein said security mark is a variation in the displayed credits corresponding to said image data.

21. The method of claim 20, wherein said variation is selected from at least one of:
a change in order of said credits;
a change in a character preceding said credits;
a change in a character behind said credits;
a change in a font used for said credits; and
displaying a group of credits selected from said displayed credits.

22. A database for storing said marking parameters for any of the methods of claim 2.

23. The method of claim 12, wherein said video data is marked by adding a security mark to a Video Object Block (VOB) corresponding to a Group of Pictures (GOP) generated from said image data.

24. The method of claim 12, wherein said security mark is selected from at least one of: a logo, a visual graphic, text, and a serial number.

25. The method of claim 12, wherein said security marking method is used for creating at least one of: a videotape, a digital versatile disc, and encoded video data.

26. A copying system is used for implementing for any of the methods claimed in claim 12.

27. The copying system of claim 26, wherein said system comprises:
a storage device for storing said video image data;
a system controller for operating said copying system;
a computer system for inserting said security mark into said video image data;
a copying device that uses said marked image data to create a physical copy; and
a controller for controlling said copying device.
